(19) United States
(12) Patent Application Publication
(10) Pub. No.: US 2013/0025889 A1
(43) Pub. Date: Jan. 31, 2013

(54) Directional control drag bar rudder and drag plate devise for a rotary tiller

(71) Applicant: Juraj Fistonich, San Pedro, CA (US)

(72) Inventor: Juraj Fistonich, San Pedro, CA (US)

(21) Appl. No.: 13/136,225

(22) Filed: Jul. 27, 2011

(51) Int. Cl. A01B 33/02

(52) U.S. Cl. 172/351

(57) ABSTRACT

A movable drag bar rudder directional control device with an attached horizontal drag plate which provides a powered rotary tiller with a means of readily controlling the machine's direction, depth of cultivation and rate of forward progress and which may be manipulated and operated with a minimum of physical effort.

### CROSS REFERENCE TO RELATED APPLICATIONS

| | | | |
|---|---|---|---|
| 445,846 | February 1891 | Butt | 172/291 |
| 1,222,388 | April 1917 | Glenn | 171/67 |
| 2,803,183 | August 1957 | Smithburn | 172/43 |
| 4,838,357 | June 1989 | Adachi | 172/43 |
| 5,197,551 | March 1993 | Farley | 172/42 |
| 6,540,031 | April 2003 | Sasaoka | 172/42 |

### BACKGROUND

### Field of Invention

The present invention relates to the field of garden rotary tillers which are provided with an improved directional control drag bar rudder and drag plate device.

Powered rotary tillers have been used to break up the soil in small plots and gardens since the 1930's. There are three significant handling difficulties presented by powered rotary tillers which include controlling the rate of travel, controlling the depth of cultivation and controlling the direction of the machine.

The first handling difficulty encountered by powered rotary tillers is the strong tendency to rapidly “walk” along the ground under the power of the rotating times. Under most conditions it is preferred that the tiller move along at a slower rate so that the rotating tines have an opportunity to dig deeper into the soil and break it up. The most common device to slow down the tiller is known as the “drag stake” or “drag bar” which sticks in the ground and engages the soil behind the tiller to provide drag on the forward movement of the machine.

The second handling difficulty presented by rotary tillers concerns controlling the depth of cultivation. Raising or lowering the drag bar adjusts the depth into the ground that the tiller cultivates by providing more or less penetration into the ground.

The third handling difficulty posed by powered rotary tillers is the lack of maneuverability of the device. The rotating tines pull the device in a forward direction but in the current models no part of the device assists in turning the tiller to the right or the left other than the force exerted by the operator. When significant lateral force is applied to the machine's handle bars it often leads to downward pressure which tends to push the drag bar further into the ground which increases the difficulty of directing the path and depth of the rotary tiller.

There have been many versions of fixed or vertically adjustable drag bars that slow the forward movement of the machine and aid in depth control. However, most of these fixed or vertically adjustable drag bars do not assist in aiding the directional movement of the device as it moves forward. In fact, the fixed nature of these drag bars means that the operator must use significant force against the drag bar or the machine's handle bars to push the drag bar sideways through the significant impediment of the soil in order to turn the machine to the right or to the left. On many of these devices the only other option is to lift the drag bar out of the soil and physically turn the machine to the left or to the right but this maneuver eliminates the drag aspect of the drag bar and is cumbersome, difficult and unsatisfactory.

### SUMMARY OF THE INVENTION

Therefore, it is an object of the present invention to provide an improved drag bar rudder directional control device for a powered rotary tiller which provides a means of readily controlling its direction, depth of cultivation and rate of forward progress and which may be manipulated and operated with a minimum of physical effort.

It is a further object of the present invention to provide a rotary tiller with a vertical drag bar rudder attached to a movable drag bar stake which extends downwardly from a control arm to penetrate and engage the ground whereby an operator applied directional force on the machine's handlebars changes the degree of engagement of the drag bar rudder with the ground to alter the direction of movement and rate of travel of the tiller.

It is another object of the present invention to provide a drag plate control device attached to a rotary tiller drag bar stake which allows selective adjustment of the depth of tilling through upward or downward directional pressure on the machine's handle bars.

It is another object of the present invention to provide a drag bar stake control device which allows the user to slow the forward progress of a powered rotary tiller over the ground.

It is another object of the present invention to provide a directional control rudder device for a powered rotary tiller which is inexpensive and may be adapted rapidly and easily to a variety of powered rotary tiller models.

Other advantages, objects and features of the present invention will appear from reading the following description in conjunction with the accompanying drawings.

### DESCRIPTION OF THE PREFERRED EMBODIMENT

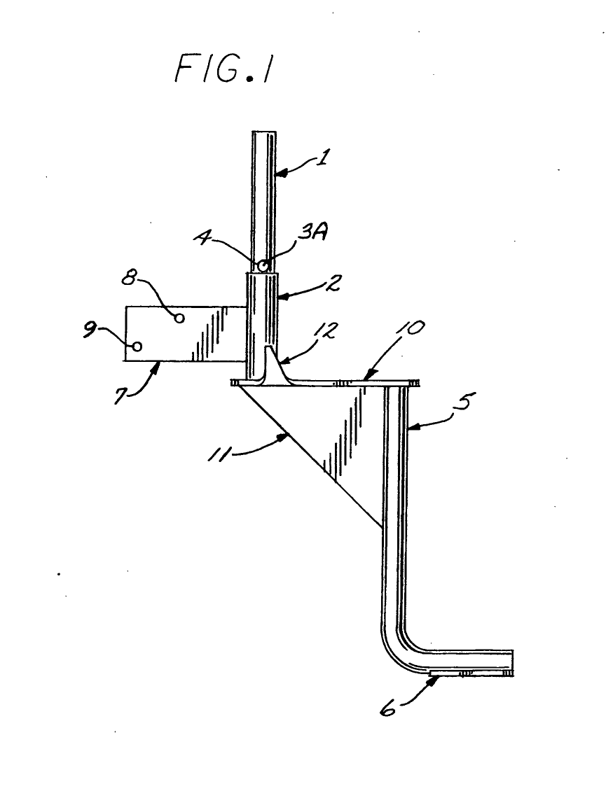

FIG. 1 is a side elevational view of the of assembled directional control rudder device.

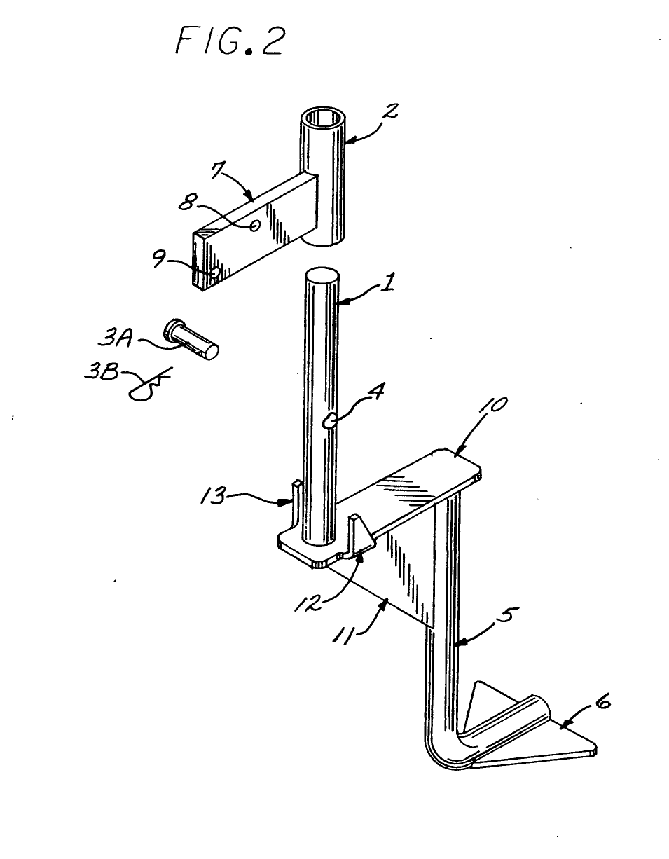

FIG. 2 is a frontal perspective of a directional control rudder device showing the functional components thereof.

FIG. 3 is a side elevational view of the shaft, rudder, stake and drag plate portion of the directional control rudder device.

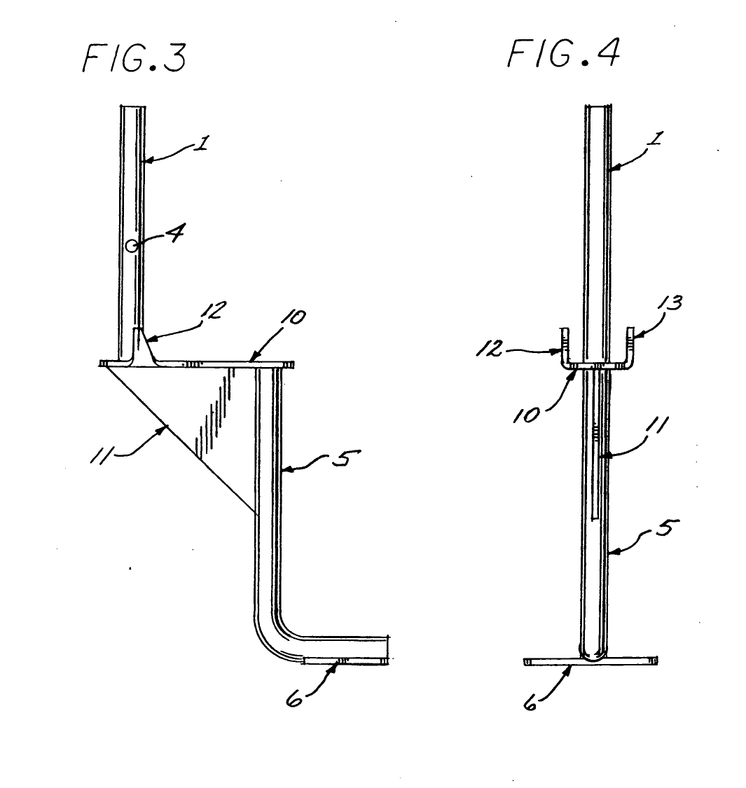

FIG. 4 is a front elevational view of the shaft, rudder, stake and drag plate portion of the directional control rudder device.

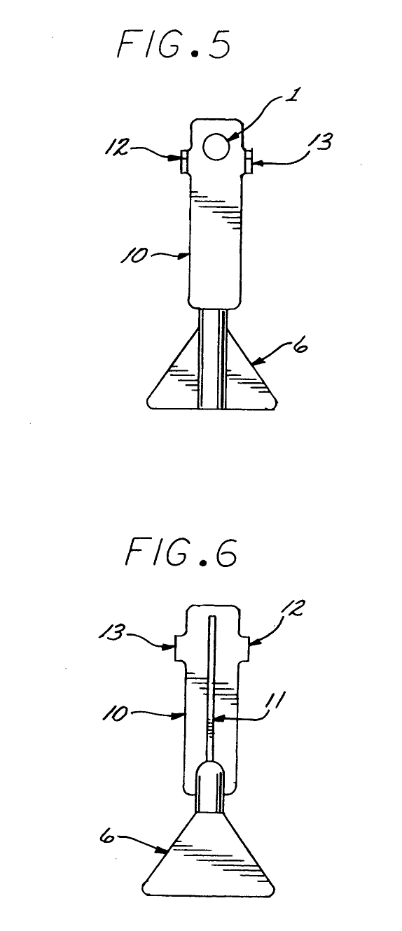

FIG. 5 is a top elevational view of the shaft, rudder, stake and drag plate portion of the directional control rudder device.

FIG. 6 is a bottom elevational view of the shaft, rudder, stake and drag plate portion of the directional control rudder device.

### DESCRIPTION OF THE PREFERRED EMBODIMENT

Referring to FIG. 2 a tubular socket support element 2 attached to a control arm 7 which mounts to the rearward drag bar extension arms of the tiller frame in the same manner as the conventional drag bar by means of bolts or other fastening devices through holes 8 and 9. The drag bar rudder shaft 1 inserts into said tubular socket support element 2 up to the horizontal drag bar rudder shaft base 10 and is secured by means of a bolt or locking pin 3a and 3b inserted through hole 4 in the drag bar rudder shaft 1 so that the drag bar rudder shaft 1 is free to swivel left or right about the vertical axis of said drag bar rudder shaft 1 in trailing relation to the forward movement of the tiller. FIG. 1.

When the rotating tines of the tiller engage the ground the result is a propensity for the tiller to “walk” across the surface of the ground unless the tiller is restrained by the drag bar stake 5 which engages with the soil to slow the movement of the tiller. Vertical direction control to press the tines of the tiller further into the ground is accomplished by an upward pressure on the tiller handle bars which lowers the front edge of the horizontal drag plate 6 as the tiller moves forward to cause said drag plate to dig deeper into the soil and increase the downward pressure on the rotating tines. Conversely, a downward pressure on the tiller handlebars lifts the front edge of the horizontal drag plate 6 and causes an upward pressure on the rotating tines as the tiller moves forward which decreases the depth of the tines at the direction of the operator.

Side to side directional control of the tiller as it moves forward is accomplished by a applying a sideways force on the machine's handlebars which causes friction and resistance against the drag bar rudder plate 11 to rotate the drag bar shaft within the hollow cylindrical support element 2 and turn the tiller. Vertical protuberances 12 and 13 rising upward from the edge of the drag bar rudder shaft plate 10 on either side of the drag bar rudder shaft 1 from rotating inside the hollow cylindrical support element 2 beyond 90 degrees from the center line of the rotary tiller.

By way of example, and not limitation, the path of the rotary tiller toward the user's right would be accomplished by directing pressure against the machine's handlebars to the users left. The leftward pressure causes the drag bar rudder plate 11 engaging the ground to pivot the vertical drag bar rudder shaft 1 in a counterclockwise direction within the hollow cylindrical support element 2 to change the forward directional movement of the tiller to the user's right. Conversely, as the tiller moves in a forward direction, a sideways pressure on the machine's handlebars to the user's right causes the drag bar rudder plate 11 to pivot the vertical drag bar rudder shaft 1 in a clockwise direction within the hollow cylindrical support element 2 to change the forward directional movement of the tiller to the user's left. As the tiller moves forward the momentum of the machine caused by the rotating tines of the tiller assists the turning force applied by the operator to the machine's handlebars and makes the pressure needed for side to side directional changes significantly less than that required of conventional drag bars.

An additional feature of the present invention is its utility in guiding a rotary tiller along an inclined surface. When working along hillsides or mounds or earth the rotary tiller must be operated at an incline from side-to-side. During this kind of operation the weight of the tiller produces a sideways force which has a tendency to push the tiller downwardly along the hillside. Through the use of the present invention the operator is able to direct sideways pressure on the handlebars towards the bottom of the hill to steer the device up the incline and counteract this tendency of the rotary tiller to move downhill and thereby maintain the rotary tiller at the proper distance up the hillside.

Having described the invention, what is claimed as new is:

1. A mountable control arm extending rearwardly from a rotary tiller frame that is integrally attached to a hollow cylindrical support element having means to insert and secure a drag bar rudder device in a manner which allows the drag bar rudder device shaft to pivot within the hollow cylindrical support element to provide right or left directional control through the application of sideways pressure on the rotary tiller handlebars as the rotating tiller tines move the device forward.

2. A vertical drag bar stake with an attached vertical drag bar rudder plate extending downwardly into the ground whereby user applied sideways pressure on the rotary tiller handlebars changes the direction of said drag bar rudder plate through the assistance of power created by the forward momentum of the rotating tiller tines.

3. A horizontal drag bar plate attached to a vertical drag bar shaft wherein user applied up or down pressure on the rotary tiller handlebars changes the angle and depth of engagement of said drag bar rudder plate as it moves through the soil.
